(19) United States
(12) Patent Application Publication
(10) Pub. No.: US 2025/0203309 A1
(43) Pub. Date: Jun. 19, 2025

(54) SOUND SYSTEM

(71) Applicant: NIPPON TELEGRAPH AND TELEPHONE CORPORATION, Tokyo (JP)

(72) Inventors: Masahiro FUKUI, Tokyo (JP); Kazunori KOBAYASHI, Tokyo (JP); Noriyoshi KAMADO, Tokyo (JP); Yohei WAKISAKA, Tokyo (JP)

(73) Assignee: NIPPON TELEGRAPH AND TELEPHONE CORPORATION, Tokyo (JP)

(21) Appl. No.: 18/849,039

(22) PCT Filed: Mar. 28, 2022
(86) PCT No.: PCT/JP2022/014992

§ 371 Date: Sep. 20, 2024

(51) Int. Cl. H04S 7/00; H04R 5/02; H04R 5/04; H04S 1/00

(52) U.S. Cl. CPC H04S 7/30; H04R 5/023; H04R 5/04; H04S 1/007; H04R 2499/13; H04S 2400/11

(57) ABSTRACT

A sound system capable of reducing the number of speakers required for performing localized reproduction in stereo is provided. A first speaker emits a sound based on an L (2n−1)-th processed acoustic signal with signal processing to make it audible in a first region in an L direction to an L (2n−1)-th acoustic signal and an R (2n)-th processed acoustic signal with signal processing to make it non-audible in a fourth region in an R direction to an R (2n)-th acoustic signal, and a second speaker emits a sound based on an L (2n)-th processed acoustic signal with signal processing to make it non-audible in a second region in an L direction to an L (2n)-th acoustic signal and an R (2n−1)-th processed acoustic signal with signal processing to make it audible in a third region in an R direction to an R (2n−1)-th acoustic signal.

### TECHNICAL FIELD

The present invention relates to a sound localized reproduction technique.

### BACKGROUND ART

There is a technique for realizing localized reproduction of an acoustic signal by using at least two speakers as a pair (refer to PTL 1).

### CITATION LIST

### Patent Literature

[PTL 1] WO 2021/192166

### SUMMARY OF INVENTION

### Technical Problem

In PTL 1, a technique is disclosed in which a plurality of speakers can be heard by a user only at a localized location in a vicinity of a speaker system by utilizing bi-directivity of the speakers without using a speaker box. However, since the technique described in PTL 1 performs the localized reproduction of 1 ch by using two speakers, at least four speakers are required when stereo reproduction is performed. When the number of necessary speakers is increased, occupied volume and weight are increased, and cost is doubled.

Therefore, in the present invention, it is an object to provide a sound system capable of reducing the number of speakers required for performing localized reproduction in stereo.

### Solution to Problem

In an aspect of the present invention, a sound system includes a speaker unit pair including at least a first speaker that does not include a speaker box and a second speaker that does not include a speaker box. An L (2n−1)-th acoustic signal is an acoustic signal of one channel of stereo channels of a predetermined sound source, an R (2n−1)-th acoustic signal is an acoustic signal of the other channel of the stereo channels, an L (2n)-th acoustic signal is an acoustic signal of an opposite phase to that of the L (2n−1)-th acoustic signal, an R (2n)-th acoustic signal is an acoustic signal of an opposite phase to that of the R (2n−1)-th acoustic signal, a first speaker emits a sound based on an L (2n−1)-th processed acoustic signal with signal processing to make it audible in a first region in an L direction to the L (2n−1)-th acoustic signal and an R (2n)-th processed acoustic signal with signal processing to make it non-audible in a fourth region in an R direction to the R (2n)-th acoustic signal, and a second speaker emits a sound based on an L (2n)-th processed acoustic signal with signal processing to make it non-audible in a second region in an L direction to the L (2n)-th acoustic signal and an R (2n−1)-th processed acoustic signal with signal processing to make it audible in a third region in an R direction to the R (2n−1)-th acoustic signal.

In an aspect of the present invention, a sound system includes, where N is an integer of 1 or more, a reproduction device that includes an n-th reproduction unit (n=1, . . . , N) that outputs an L (2n−1)-th acoustic signal which is an acoustic signal of one channel of stereo channels of a predetermined sound source, an L (2n)-th acoustic signal which is an acoustic signal of an opposite phase to that of the L (2n−1)-th acoustic signal, an R (2n−1)-th acoustic signal which is an acoustic signal of the other channel of the stereo channels, and an R (2n)-th acoustic signal which is an acoustic signal of an opposite phase to that of the R (2n−1)-th acoustic signal, a directivity control device that includes an Ln-th directivity control unit (n=1, . . . , N) that generates an L (2n−1)-th processed acoustic signal from the L (2n−1)-th acoustic signal and generates an L (2n)-th processed acoustic signal from the L (2n)-th acoustic signal by performing predetermined signal processing, and an Rn-th directivity control unit (n=1, . . . , N) that generates an R (2n−1)-th processed acoustic signal from the R (2n−1)-th acoustic signal and generates an R (2n)-th processed acoustic signal from the R (2n)-th acoustic signal by performing predetermined signal processing, a synthesis device that includes an Ln-th synthesis unit (n=1, . . . , N) that obtains an Ln-th synthesis acoustic signal by synthesizing the L (2n-1)-th processed acoustic signal and the R (2n)-th processed acoustic signal, and an Rn-th synthesis unit (n=1, . . . , N) that obtains an Rn-th synthesis acoustic signal by synthesizing the R (2n−1)-th processed acoustic signal and the L (2n)-th processed acoustic signal, and a speaker system that includes an n-th speaker unit pair (n=1, . . . , N) that includes a speaker unit (hereinafter referred to as an Lch speaker unit) that emits a sound based on the Ln-th synthesis acoustic signal and a speaker unit (hereinafter referred to as an Rch speaker unit) that emits a sound based on the Rn-th synthesis acoustic signal. Signal processing executed by the Ln-th directivity control unit (n=1, . . . , N) is processing so that the sound emitted from the Lch speaker unit of the n-th speaker unit pair and the sound emitted from the Rch speaker unit of the n-th speaker unit pair can be heard in a region to be audible in a vicinity of the n-th speaker unit pair in an L direction and cannot be heard in a region not to be audible in an R direction, and signal processing executed by the Rn-th directivity control unit (n=1, . . . , N) is processing so that the sound emitted from the Rch speaker unit of the n-th speaker unit pair and the sound emitted from the Lch speaker unit of the n-th speaker unit pair can be heard in a region to be audible in a vicinity of the n-th speaker unit pair in an R direction and cannot be heard in a region not to be audible in an L direction.

### Advantageous Effects of Invention

According to the present invention, the number of speakers required for reproducing a sound that can be heard only in a very limited narrow range by stereo can be reduced.

### BRIEF DESCRIPTION OF DRAWINGS

FIG. 1 is a diagram for explaining directivity of a sound emitted from a speaker.

FIG. 2 is a diagram for explaining directivity of a sound emitted from a speaker unit.

FIG. 3 is a diagram for explaining a sound emitted from a speaker unit pair.

FIG. 4 is a diagram for explaining directivity of the sound emitted from the speaker unit pair.

FIG. 5 is a diagram showing a situation of an experiment (positional relationship between a speaker and a microphone).

FIG. 6 is a diagram showing a situation of an experiment (positional relationship between a speaker unit and a microphone).

FIG. 7 is a diagram showing a situation of an experiment (positional relationship between a speaker unit pair and a microphone).

FIG. 8 is a diagram showing a situation of an experiment (other measurement positions).

FIG. 9 is a diagram showing experiment results (condition 1).

FIG. 10 is a diagram showing experiment results (condition 2).

FIG. 11 is a diagram showing experiment results (condition 3).

FIG. 12 is a diagram showing experiment results (condition 4).

FIG. 13 is a diagram showing an example of a sound system installed in a seat of an aircraft.

FIG. 14 is a block diagram showing an example of a configuration of a sound system 100.

FIG. 15 is a diagram showing a situation of the sound emitted from the speaker unit pair.

FIG. 16 is a block diagram showing an example of a configuration of a sound system 200.

FIG. 17 is a block diagram showing an example of a configuration of a sound system 202.

FIG. 18 is a diagram showing an example of a configuration of a speaker unit pair 122 to which a member 1224 is attached.

FIG. 19 is a diagram showing an example of a sound system installed in a seat of an automobile.

FIG. 20 is a diagram showing an example of the sound system installed in the seat of the automobile.

FIG. 21 is a diagram showing an example of the sound system installed in the seat of the automobile.

FIG. 22 is a block diagram showing an example of a configuration of a sound system 300.

FIG. 23 is a diagram for explaining directivity of the sound emitted from the speaker unit.

FIG. 24 is a diagram for explaining the directivity of the sound emitted from the speaker unit.

### DESCRIPTION OF EMBODIMENTS

The following describes embodiments of the present invention in detail. Note that components having the same function will be denoted by the same reference numerals and redundant description thereof will be omitted.

### TECHNICAL BACKGROUND

First, directivity of a sound emitted from a speaker will be described. Next, the directivity of the sound emitted from the speaker unit pair according to the present invention of the application will be described. Finally, results of experiments for confirming effects of the speaker unit pair according to the present invention of the application will be described.

<<1: Directivity of Sound Emitted from Speaker>>

Usually, the speaker is composed of a speaker unit and a speaker box. The speaker unit is a component that includes a diaphragm that converts acoustic signals, which are electric signals, into air vibrations (that is, generates sound waves). In addition, the speaker box is a component that houses the speaker unit.

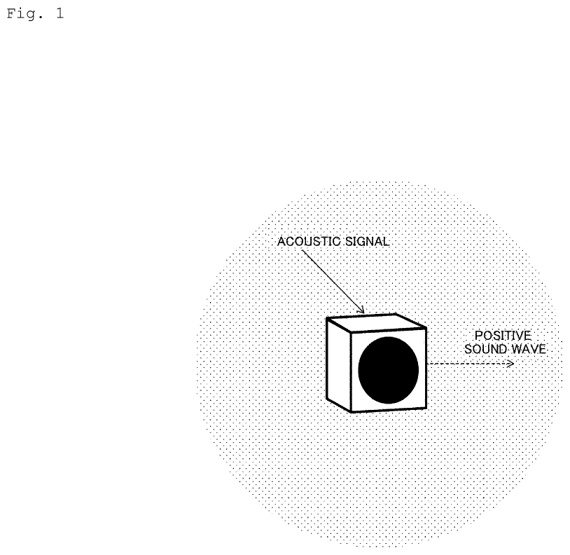

When the acoustic signal is inputted to the speaker, the diaphragm of the speaker unit vibrates, and sound waves are radiated in both directions in which the diaphragm vibrates. Here, the sound wave radiated to the outside of the speaker box (that is, the front direction of the speaker unit) is referred to as a positive sound wave, and the sound wave radiated to the inside of the speaker box (that is, the back direction of the speaker unit) is referred to as a negative sound wave. The negative sound wave is a sound wave that has an opposite phase to that of the positive sound wave. FIG. 1 is a diagram for explaining the directivity of the sound emitted from the speaker. As shown in FIG. 1, the positive sound wave is radiated from the speaker in all directions, while the negative sound wave is not radiated to the outside of the speaker box. As a result, the sound emitted from the speaker can be heard over a wide range.

<<2: Directivity of Sound Emitted from Speaker Unit Pair>>

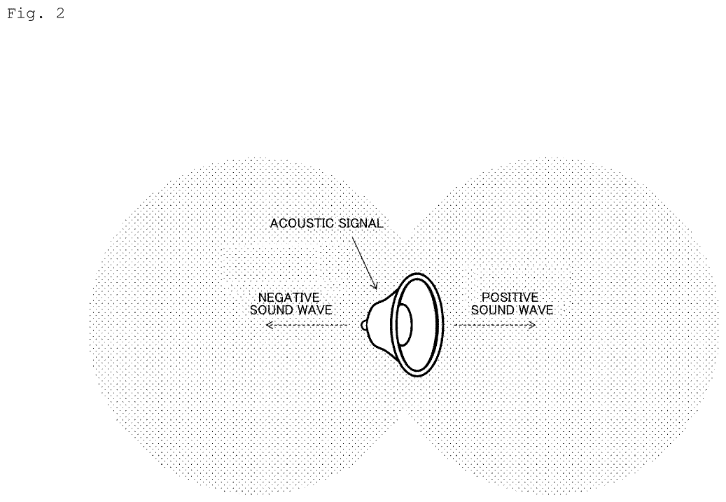

Here, the directivity of the sound emitted from the speaker unit which is a bare speaker will be described first. FIG. 2 is a diagram for explaining an example of the directivity of the sound emitted from the speaker unit. In the case of only the speaker unit, the negative sound wave is radiated from a back of the speaker unit hidden in the speaker box differently from the case of the speaker. Therefore, as shown in FIG. 2, the sound emitted from the speaker unit has a characteristic of bi-directivity.

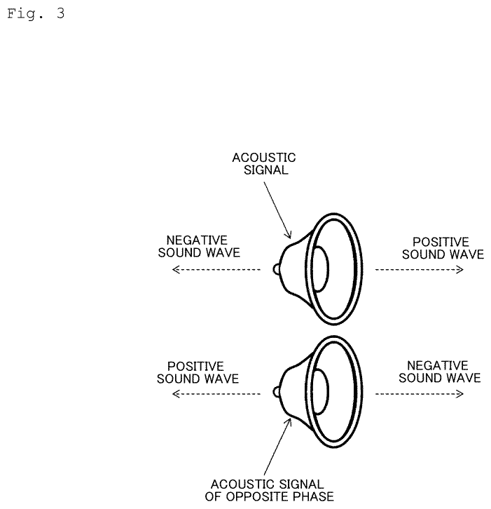

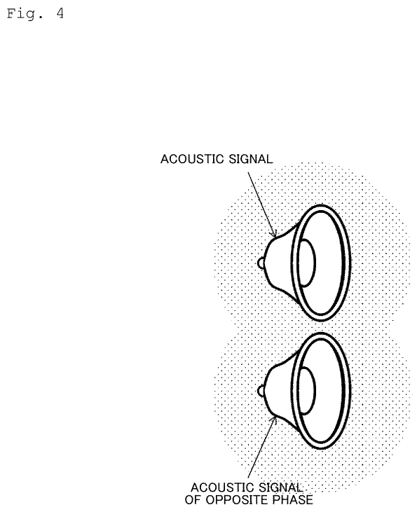

In the present invention of the application, the bi-directivity is utilized. This is described specifically hereinafter. First, as shown in FIG. 3, two speaker units are arranged to form a speaker unit pair. The two speaker units are arranged so as to emit the sound in substantially the same direction. When acoustic signals having substantially the same size and opposite phase relation are inputted to the speaker unit pair respectively, the diaphragms of the two speaker units are vibrated respectively, and sounds based on the two acoustic signals are emitted. Then, the sound released from the speaker unit pair is suppressed largely in all directions except a vicinity of the speaker unit pair, and the sound pressure approaches 0 as much as possible. For example, in FIG. 4, the sound is not erased in a point region in the vicinity of the speaker unit, but a state in which the sound cannot be heard is created outside the point region. That is, the sound is erased only at a position sufficiently distant from the speaker unit pair, and the sound is not erased in the vicinity of the speaker unit pair. The reason why the sound is not erased in the vicinity of the speaker unit pair is that when the sound waves released from each of the speaker unit pair are overlapped at an observation point, influence of a distance based on an arrival route from each speaker unit to the observation point is large. Although the effect of canceling the phase by overlapping the positive and negative directions is obtained at the far distance where the influence of the route difference due to the interval and the wraparound of the speaker unit pair is small, the route difference to an arrival between the sound wave radiated from the front of the speaker unit and the sound wave sneaking from the back is large in the vicinity of the speaker unit pair, and the positive and negative of the phases do not overlap in an exact opposite relation.

That is, when a predetermined acoustic signal is inputted to one speaker unit constituting the speaker unit pair and an acoustic signal having an opposite phase to that of the predetermined acoustic signal is inputted to the other speaker unit, it is possible to create a situation in which only a user in the vicinity of the speaker unit pair can hear and other users cannot hear the sound by utilizing a characteristic in which the sound can be heard in the vicinity of the speaker unit pair.

### <<3: Experiment Result>>

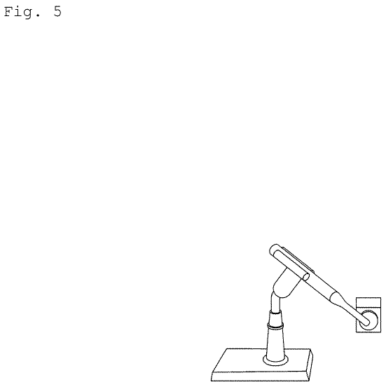

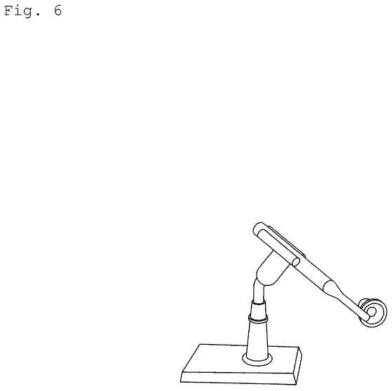

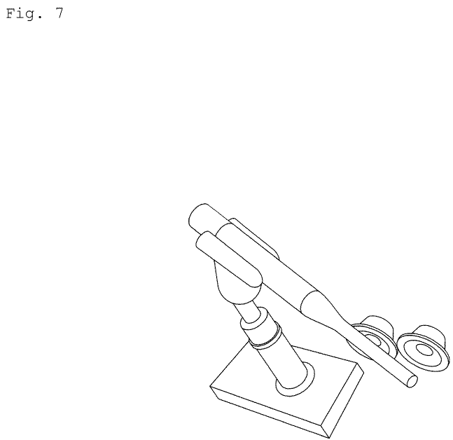

Here, results of experiments that measure frequency characteristics of the speaker, the speaker unit, and the speaker unit pair will be described. In the experiment, as the speaker, the speaker unit, and the speaker unit box, a speaker having a diaphragm of 4.5 cm in a diameter (see FIG. 5), a speaker unit in which the speaker box is removed from the speaker (see FIG. 6), and a speaker unit pair in which two speaker units are arranged (see FIG. 7) are used. In addition, in order to measure the frequency characteristics in the vicinity of the speaker, the speaker unit, and the speaker unit pair, a microphone is installed under the following four conditions.
(Condition 1) a position of 5 cm from the front of the speaker
(Condition 2) a position of 5 cm from the front of the speaker unit
(Condition 3) a position of 2 cm from the front of the speaker unit
(Condition 4) a position of 2 cm from the front of the speaker unit pair

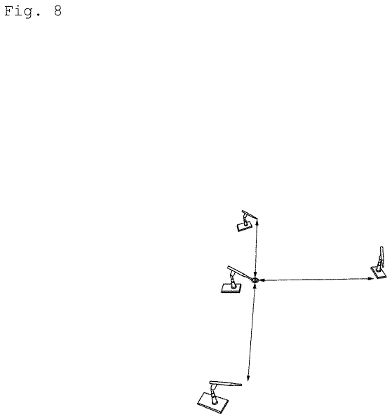

Also, for each of the conditions, for comparison, microphones are also installed at positions of 100 cm from each of the front, back, and side of the speaker, the speaker unit, and the speaker unit pair (see FIG. 8).

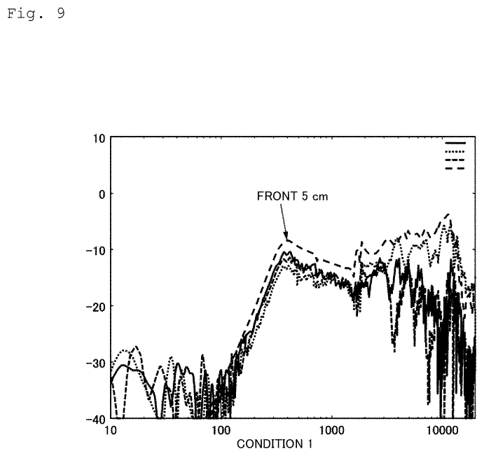

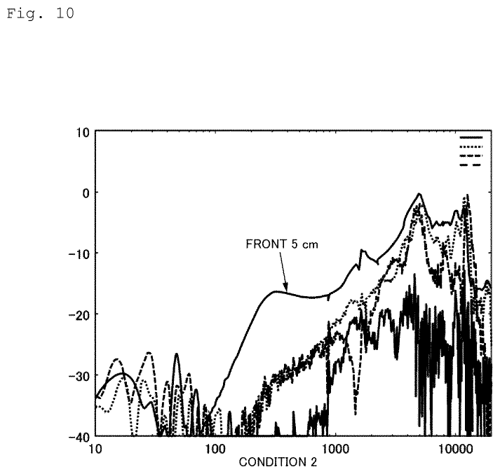

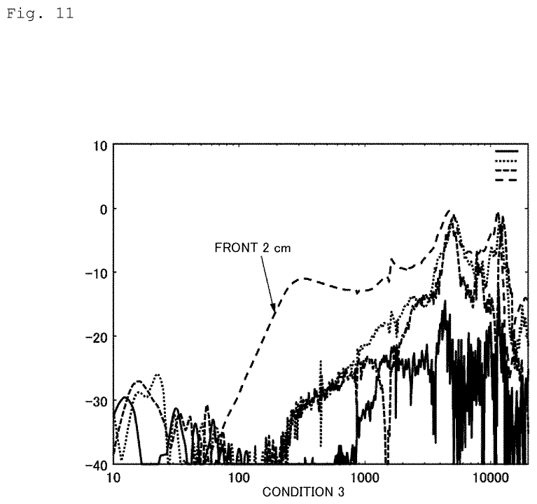

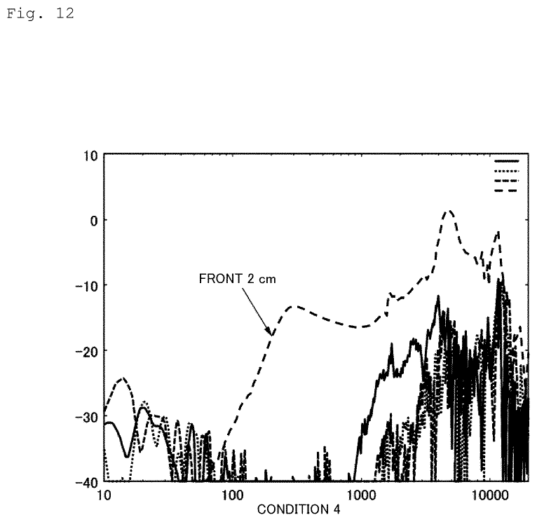

Hereinafter, the experiment results will be described. FIG. 9, FIG. 10, FIG. 11 and FIG. 12 are diagrams showing the experiment results, and showing relationships between the frequency and the attenuation under the condition 1, condition 2, condition 3, and condition 4, respectively. In all figures, four curves are shown, one curve indicated by an arrow is the experiment result in which the sound is collected by a microphone located at a position of 5 cm or 2 cm from the front, and other three curves are the experiment results in which the sounds are collected by the microphones located at a position of 100 cm from the front, the back, and the side. Note that since the curve at the position of 5 cm or 2 cm from the front is located in the vicinity of the speaker or the like, the gain becomes very large. Therefore, in order to make it easy to see, the curve at the position of 5 cm from the front is plotted by −25 dB from three curves at the position of 100 cm. Similarly, the curve at 2 cm from the front is plotted at −32 dB. Comparing FIG. 9 and FIG. 10, it can be seen that there is almost no difference between the four curves when the speaker is used, and there is a difference between the curve at the position of 5 cm from the front and other three curves when the speaker unit is used. This difference is more remarkable as it is in a lower region. Also, comparing FIG. 11 and FIG. 12, it can be seen that the speaker unit pair has a larger difference between the curve at the position of 2 cm from the front and other three curves than that of the speaker unit.

As described above, it was confirmed by the experiments that the sound emitted from the speaker unit pair of the present invention of the application was heard only in the vicinity of the speaker unit pair.

### First Embodiment

A system that reproduces an acoustic signal obtained based on a reproduction object is called a sound system. The sound system includes a speaker system in order to emit the acoustic signal as the sound (hereinafter, this sound is referred to as a sound based on the acoustic signal). Here, the speaker system is a device that converts the acoustic signal, which is an analogue signal, into the sound. In addition, the reproduction objects are data and signal in which the acoustic signal can be obtained by the predetermined processing, for example, such as data recorded in a CD, a DVD, and a record, data received by the Internet, and signals received by radio broadcasting and television broadcasting.

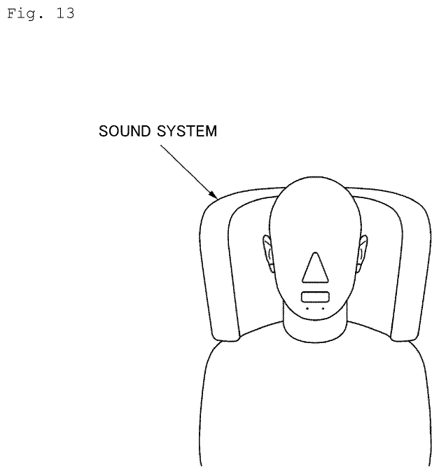

Here, the sound system in which the sound based on the acoustic signal obtained from the reproduction objects is reproduced so as to be heard only by a user in the vicinity of the speaker system will be described. That is, the reproduced sound of the sound system is not heard by users other than the user in the vicinity of the speaker system. When such a sound system is used as a sound system for a user who uses a seat of an aircraft, for example, a system can be provided which allows only the user who uses the seat to hear the reproduced sound. FIG. 13 is a diagram showing an example of the sound system installed in the seat of the aircraft. The sound system shown in FIG. 13 is installed on the seat so as to sandwich the head of a seated user, and two speaker unit pairs are arranged in the vicinity of the left and right ears. Note that such a sound system can be installed in a vehicle other than the aircraft such as an automobile and an electric train, or a reclining chair, and it can be installed even in a wearable form such as putting on a shoulder. Further, a driver unit pair, which corresponds to the speaker unit pair and is formed by arranging two driver units, may be installed in the left and right units of a headphone and an earphone. The headphones are generally divided into two types of open type (open air type) and closed type (closed type), but it is expected that sound leakage is reduced if the above-mentioned technique is applied to the open type having a risk of sound leakage.

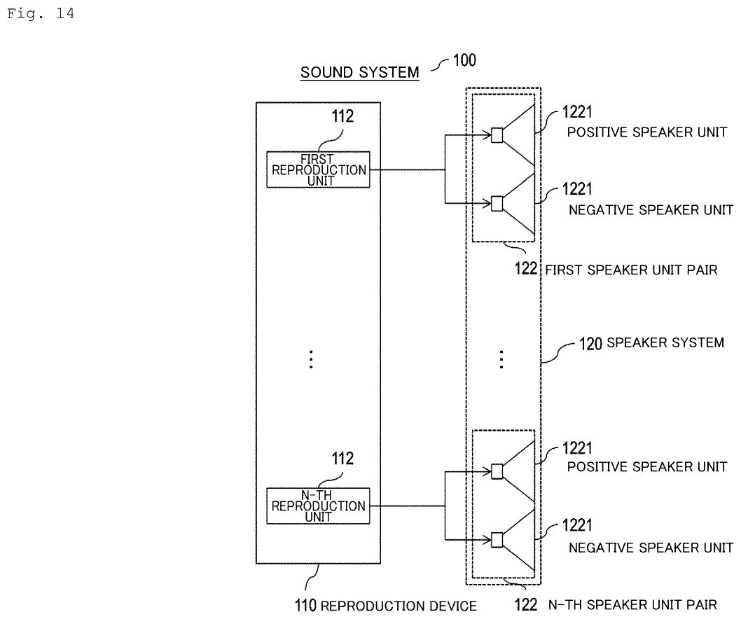

Hereinafter, a sound system 100 will be described with reference to FIG. 14. FIG. 14 is a block diagram showing a configuration of the sound system 100. As shown in FIG. 14, the sound system 100 includes a reproduction device 110 and a speaker system 120. The reproduction device 110 includes N pieces (where N is an integer of 1 or more) of reproduction units 112 (that is, a first reproduction unit 112, . . . , and an N-th reproduction unit 112). Further, the speaker system 120 includes N pieces of speaker unit pairs 122 (that is, a first speaker unit pair 122, . . . , and an N-th speaker unit pair 122). The speaker unit pair 122 includes two speaker units (that is, a positive speaker unit 1221 and a negative speaker unit 1221). The negative speaker unit 1221 inputs the acoustic signal having an opposite phase to that of the acoustic signal inputted to the positive speaker unit 1221. The speaker system 120 is installed at a place near a head of the user who uses the seat.

Note that the direction in which the n-th speaker unit pair 122 faces the user is defined as an n-th user direction (n=1, . . . , N), and the positive speaker unit 1221 and the negative speaker unit 1221 of the n-th speaker unit pair 122 (n=1, . . . , N) are arranged so that the sound emitted in the opposite direction to the n-th user direction from the positive speaker unit 1221 and the sound emitted in the opposite direction to the n-th user direction from the negative speaker unit 1221 are transmitted in the n-th user direction by the wraparound. Here, the n-th user direction is the front direction of the positive speaker unit 1221 and the negative speaker unit 1221 of the n-th speaker unit pair 122. In addition, the opposite direction to the n-th user direction is the back direction of the positive speaker unit 1221 and the negative speaker unit 1221 of the n-th speaker unit pair 122.

Further, the positive speaker unit 1221 and the negative speaker unit 1221 of the n-th speaker unit pair 122 (n=1, . . . , N) are arranged in a positional relationship in which the sound emitted from the positive speaker unit 1221 and the sound emitted from the negative speaker unit 1221 are erased from each other so that a user who uses another seat cannot hear the sound.

The operations of the sound system 100 will be described in accordance with FIG. 14 in below.

The reproduction device 110 inputs a first acoustic signal, a third acoustic signal, . . . and a 2N−1 acoustic signal which are acoustic signals obtained based on the reproduction objects, and outputs the first acoustic signal, the second acoustic signal, . . . , and the 2N acoustic signal. More specifically, an n-th reproduction unit 112 (n=1, . . . , N) inputs a 2n−1 acoustic signal, generates a 2n acoustic signal which is an acoustic signal having an opposite phase to that of the 2n−1 acoustic signal from the 2n−1 acoustic signal, and outputs the 2n−1 acoustic signal and the 2n acoustic signal. The 2n−1 acoustic signal and the 2n acoustic signal are respectively inputted to the positive speaker unit 1221 and the negative speaker unit 1221 of the n-th speaker unit pair 122.

The speaker system 120 inputs the first acoustic signal, the second acoustic signal, . . . , and the 2N acoustic signal outputted by the reproduction device 110, and emits a sound based on the first acoustic signal, a sound based on the second acoustic signal, . . . , and a sound based on the 2N acoustic signal. More specifically, the n-th speaker unit pair 122 (n=1, . . . , N) inputs the 2n−1 acoustic signal and the 2n acoustic signal, and emits the sound based on the 2n−1 acoustic signal from the positive speaker unit 1221, and emits the sound based on the 2n acoustic signal from the negative speaker unit 1221. Since the 2n−1 acoustic signal and the 2n acoustic signal have an opposite phase relationship to each other, the sound can be heard only in the vicinity of the seat where the speaker system 120 is installed, as described in <Technical Background>. For example, in the case where N=2 is established, when the first acoustic signal and the third acoustic signal are respectively an acoustic signal of a right channel and an acoustic signal of a left channel of a certain sound source, a stereo sound can be heard only in the vicinity of the seat where the speaker system 120 is installed.

Note that the sound emitted in the n-th user direction from the positive speaker unit 1221 of the n-th speaker unit pair 122 and the sound emitted in an opposite direction to the n-th user direction from the positive speaker unit 1221 of the n-th speaker unit pair 122 have an opposite phase relationship to each other. Similarly, the sound emitted in the n-th user direction from the negative speaker unit 1221 of the n-th speaker unit pair 122 and the sound emitted in an opposite direction to the n-th user direction from the negative speaker unit 1221 of the n-th speaker unit pair 122 have an opposite phase relationship to each other.

According to the embodiment of the present invention, it is possible to reproduce the sound that can be heard only in the very limited narrow range in the vicinity of the speaker system. Note that the vicinity is a distance defined in consideration of experiment results based on environment in accordance with frequency and degree of sound erasure. For example, in the case where a state of the sound at a distance where a sound pressure at a position separated from the center of the speaker diaphragm by about the diameter of the speaker diaphragm is changed to a sound pressure equivalent to a background noise by gradually separating from the center of the speaker diaphragm is regarded as the erasure of the sound in <<3: Experiment Result>>, the “vicinity” is set to a distance separated from the center of the speaker diaphragm by about twice the diameter of the speaker diaphragm, for example. In addition, in another way, when an environment having a certain degree of background noise such as inside a vehicle is assumed, the range of vicinity is set so that a person sitting on the seat where the speaker system 120 is installed can hear and a person sitting on the adjacent seat cannot hear. For example, in the case where the sound radiated from the speaker unit is radiated to the periphery and becomes a sound pressure equivalent to the background noise is regarded as the erasure of the sound in <<3: Experiment Result>>, the “vicinity” can be regarded as a distance of about twice the shoulder width of the user from the center of the speaker diaphragm.

### Second Embodiment

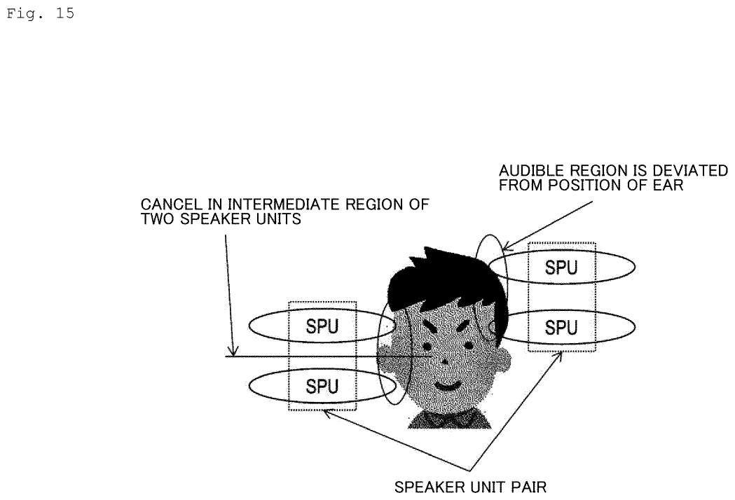

FIG. 15 is a diagram showing a situation of the sound emitted from the speaker unit pair. An SPU in the figure represents the speaker unit. In the case of the speaker unit pair installed near the right ear, sounds from the respective speaker units cancel each other in the intermediate region of the two speaker units, so that a region where the sounds emitted from the speaker unit pair cannot be heard is generated, and the user cannot hear the sounds. On the other hand, in the case of the speaker unit pair installed near the left ear, a region where the sound emitted from the speaker unit pair can be heard is deviated from the position of the ear, so that the user cannot hear the sounds. That is, (i) when both or either one of the right and left ears are located in the intermediate region, (ii) when both or either one of the right and left ears are deviated from the audible region, or (iii) when either one of the right and left ears is located in the intermediate region and the other is deviated from the audible region, a situation occurs in which a user cannot hear the sound or hardly hears the sound. In order to solve such a problem, the directivity of the sound emitted from the speaker unit pair is controlled. Here, a sound system for performing directivity control processing will be described.

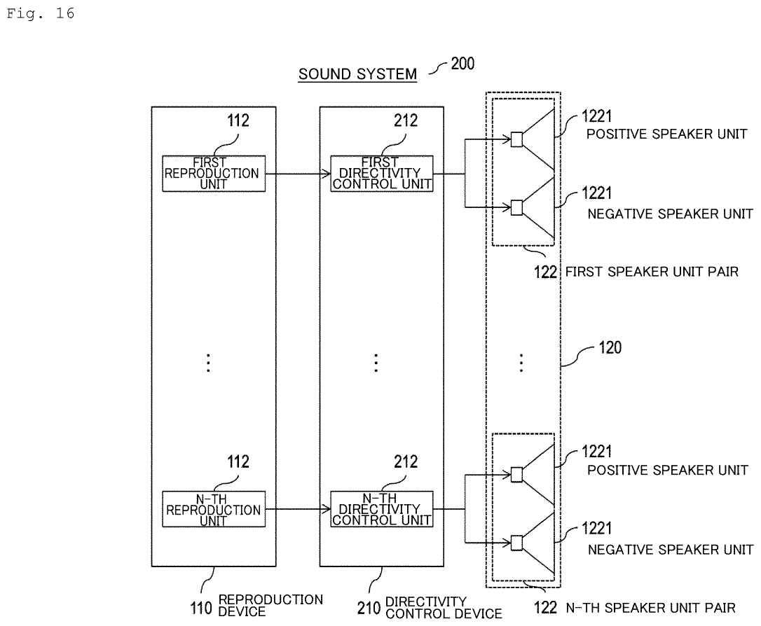

Hereinafter, a sound system 200 will be described with reference to FIG. 16. FIG. 16 is a block diagram showing a configuration of the sound system 200. As shown in FIG. 16, the sound system 200 includes the reproduction device 110, a directivity control device 210, and the speaker system 120. The directivity control device 210 includes N pieces of directivity control units 212 (that is, a first directivity control unit 212, an N-th directivity control unit 212). The sound system 200 is different from the sound system 100 in that it includes the directivity control device 210. In the following, the operations of the directivity control device 210 and the speaker system 120 will be described in accordance with FIG. 16.

The directivity control device 210 inputs the first acoustic signal, the second acoustic signal, . . . , and the 2N acoustic signal outputted by the reproduction device 110, and outputs a first processed acoustic signal which is a signal obtained by signal processing the first acoustic signal, a second processed acoustic signal which is a signal obtained by signal processing the second acoustic signal, . . . , and a 2N processed acoustic signal which is a signal obtained by signal processing the 2N acoustic signal. More specifically, a n-th directivity control unit 212 (n=1, . . . , N) inputs the 2n−1 acoustic signal and the 2n acoustic signal, generates a 2n−1 processed acoustic signal from the 2n−1 acoustic signal and a 2n processed acoustic signal from the 2n acoustic signal by executing predetermined signal processing, and outputs the 2n−1 processed acoustic signal and the 2n processed acoustic signal. Here, the predetermined signal processing is processing for controlling the directivity, and for example, a method of Reference Document 1, other directivity control techniques can be used. It is needless to say that the predetermined signal processing may be realized by the directivity control by other methods. In short, any technique may be used as long as the directivity control can be performed in accordance with the position of the user's ear and the position of the speaker unit pair.

(Reference Document 1) Futoshi Asano, “Array signal processing of sound-localization, tracking and separation of sound source”, CORONA PUBLISHING CO., LTD., 2011, p. 69-91 The predetermined signal processing is, for example, filtering using an FIR (Finite Impulse Response) filter. The FIR filter used here is designed so that microphones are respectively installed in a region to be audible and a region not to be audible, that the value of the filter coefficient is made to approach 1 in the microphone installed in the region to be audible, and that the value of the filter coefficient is made to approach 0 in the microphone installed in the region not to be audible. This is described specifically hereinafter. The region to be audible and the region not to be audible need to be designed in accordance with the case. For example, a case to be installed in the seat (hereinafter referred to as a seat S) of the automobile is considered. A position where the ear is present when a user who uses the seat S moves the head or changes the direction of the face is included in the region to be audible, and a position where the ear is present when a user who uses a seat close to the seat S (for example, an adjacent seat or front and rear seats) moves the head or changes the direction of the face is included in the region not to be audible. Therefore, for example, in a microphone installed in the region including the seat close to the seat S but not including the seat S, the value of the filter coefficient is made to approach 0. Note that in consideration that the sound may not be heard even at the position where the ear is present when the head is moved or the direction of the face is changed because of the fact that the sounds cancel each other in the intermediate region between the two speaker units as described above, and the value of the filter coefficient in the microphone installed in the intermediate region is made to approach 1. In short, the microphone installed in the region where the user's ear is assumed to be present should be controlled so that the filter coefficient is made to approach 1, and the microphone installed in the region where the user's ear is assumed not to be present should be controlled so that the filter coefficient is made to approach 0. In other words, the filter may be configured so that the sound as large as possible may arrive in the region where the user's ear is assumed to be present, and the sound as small as possible may arrive in the region where the user's ear is assumed not to be present.

As a result, the n-th directivity control unit (n=1, . . . , N) executes the signal processing so that the sound emitted from the positive speaker unit of the n-th speaker unit pair and the sound emitted from the negative speaker unit of the n-th speaker unit pair can be heard in the region to be audible in the vicinity of the n-th speaker unit pair and cannot be heard in the region not to be audible. Note that the region to be the audible region includes a point located at an equal distance from the positive speaker unit of the n-th speaker unit pair and the negative speaker unit of the n-th speaker unit pair, in which the sound emitted from the positive speaker unit of the n-th speaker unit pair and the sound emitted from the negative speaker unit of the n-th speaker unit pair cancel each other.

The speaker system 120 inputs the first processed acoustic signal, the second processed acoustic signal, . . . , and the 2N processed acoustic signal outputted by the directivity control device 210, and emits the sound based on the first processed acoustic signal, and emits the sound based on the second processed acoustic signal, . . . , and the sound based on the 2N processed acoustic signal. More specifically, the n-th speaker unit pair 122 (n=1, . . . . N) inputs the 2n−1 processed acoustic signal and the 2n-th processed acoustic signal, and emits the sound based on the 2n−1 processed acoustic signal from the positive speaker unit 1221, and the sound based on the 2n-th processed acoustic signal from the negative speaker unit 1221.

### Modification Example

Here, a sound system in which a higher region sound is hardly leaked by using a member having a sound absorption characteristic will be described.

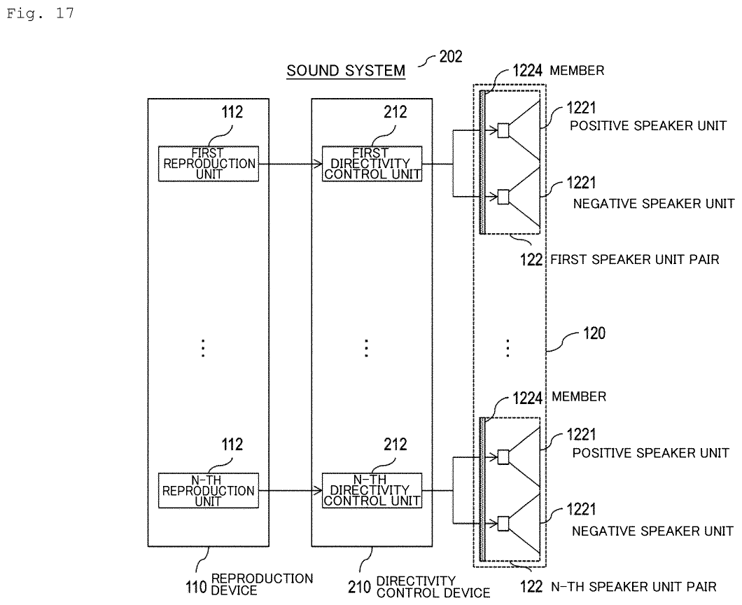

Hereinafter, a sound system 202 will be described with reference to FIG. 17. FIG. 17 is a block diagram showing a configuration of the sound system 202. As shown in FIG. 17, the sound system 202 includes the reproduction device 110, the directivity control device 210, and the speaker system 120, similarly to the sound system 200. However, the sound system 202 is different from the sound system 200 in that a member 1224 is attached to the speaker unit pair 122.

The structure of the n-th speaker unit pair 122 (n=1, . . . . N) will be described below in accordance with FIG. 17.

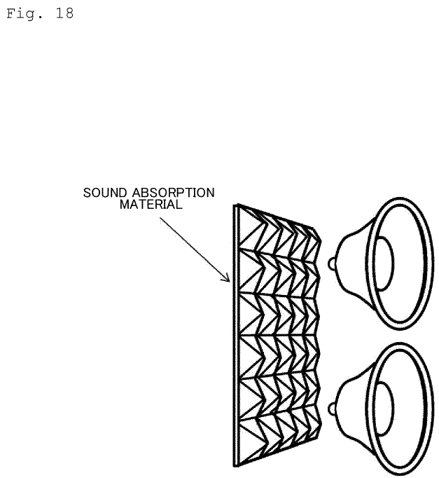

The n-th speaker unit pair 122 is provided with the member 1224 that absorbs sounds emitted in the opposite direction to the n-th user direction from the positive speaker unit 1221 and the negative speaker unit 1221 of the n-th speaker unit pair 122 (see FIG. 18). The member 1224 may be any member as long as it can prevent higher region sound from being radiated on the back. Note that instead of installing the member 1224 only on the back of the speaker unit pair 122, the member 1224 may be installed so as to surround other than the front of the speaker unit pair 122.

### (Example of Sound System Installed in Seat of Automobile)

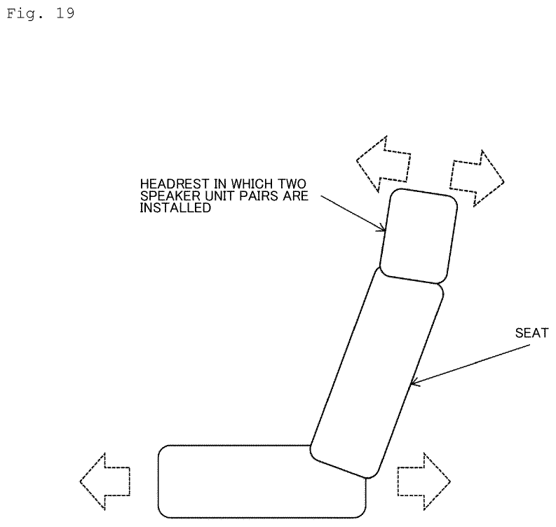

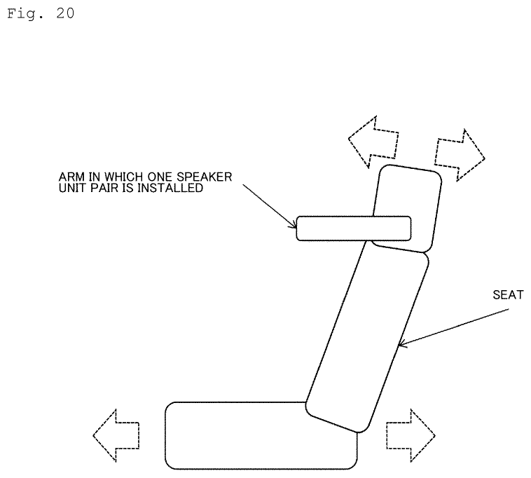

FIG. 19 and FIG. 20 are diagrams showing examples of sound systems installed in seats of automobiles, respectively. In the example shown in FIG. 19, a speaker unit pair is installed on a headrest of the seat of the automobile. Specifically, N=2 is established, and a first speaker unit pair and a second speaker unit pair are installed on the headrest of the seat of the automobile. On the other hand, in the example shown in FIG. 20, a speaker unit pair is installed on an arm that can be attached to the seat of the automobile. Specifically, N=2 is established, and the speaker unit pairs are respectively installed on two arms attached to the seat so as to sandwich the head of a user who uses the seat of the automobile. Note that the arm may be a movable type.

### Other Examples

Examples other than the seat of the automobile, specifically, a seat for an amusement machine such as a pachinko machine and a slot machine, will be described. Usually, a user uses a seat in front of the amusement machine to enjoy the amusement on the amusement machine. Therefore, the arm as described in the example of the automobile may be installed for the seat of the amusement machine, and the speaker unit pair may be present near the position where the ear of the user seated on the seat is present. Note that since the seat of the amusement machine has no backrest, the arm may be installed on the amusement machine instead of installing the arm on the seat. Alternatively, the arm may be a movable type, and the user may adjust the speaker unit pair so that the speaker unit pair is present near the ear.

### Third Embodiment

In the sound system of the second embodiment, only acoustic signal of one channel (monaural) can be reproduced by one speaker unit pair. If acoustic signals of two channels (stereo) is to be reproduced, at least two speaker unit pairs are required.

In the present embodiment, a sound system capable of reproducing acoustic signals of two channels (stereo) by one speaker unit pair will be described. Prior to the details, an overview of the present embodiment will be described. As described above, a configuration in which a positive speaker unit (hereinafter also referred to as a first speaker) and a negative speaker unit (hereinafter also referred to as a second speaker) are in opposite phases to each other and any speaker does not have a speaker box is adopted, thereby realizing the sound system which can be heard only in the vicinity. In the present embodiment, the first speaker and the second speaker have two roles, respectively. In this case, for simplification of the description, a speaker that emits an acoustic signal for listening is called a main speaker, and the other speaker is called a cancel speaker. The role of the Lch main speaker and the role of the Rch cancel speaker are given to the first speaker, and the role of the Lch cancel speaker and the role of the Rch main speaker are given to the second speaker. By giving directivity to signals emitted from the first speaker and the second speaker so as to serve as such a role, a stereo acoustic signal which can be heard only in the vicinity can be reproduced by one speaker unit pair.

In the present embodiment, acoustic signals obtained based on the reproduction objects are acoustic signals of two channels (stereo).

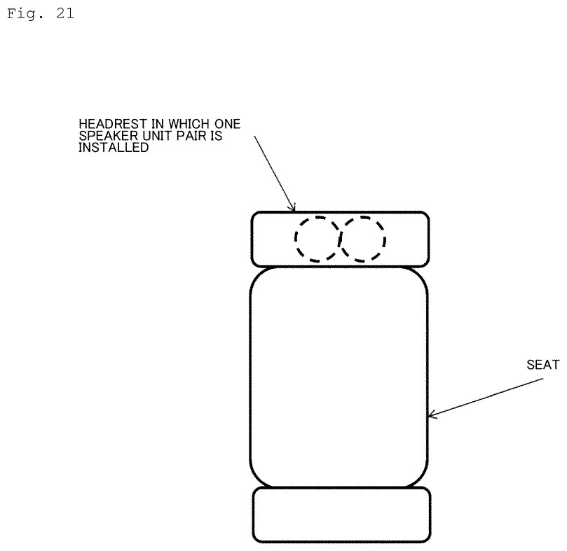

FIG. 21 is a diagram showing an example of the sound system installed in a seat of an aircraft. The sound system shown in FIG. 21 is installed on a headrest of the seat, and two speaker units included in one speaker unit pair are arranged in a horizontal direction at the center of the headrest. Note that although the seat of the aircraft is described as an example, it may be applied to a seat of an automobile, a seat of an electric train, an office chair, or a speaker unit pair installed in a separator or a digital signage. In short, the invention described in the present embodiment may be applied to any sound system which reproduces stereo acoustic signals that can be heard only in the vicinity with a smaller number of speakers than that in the first embodiment.

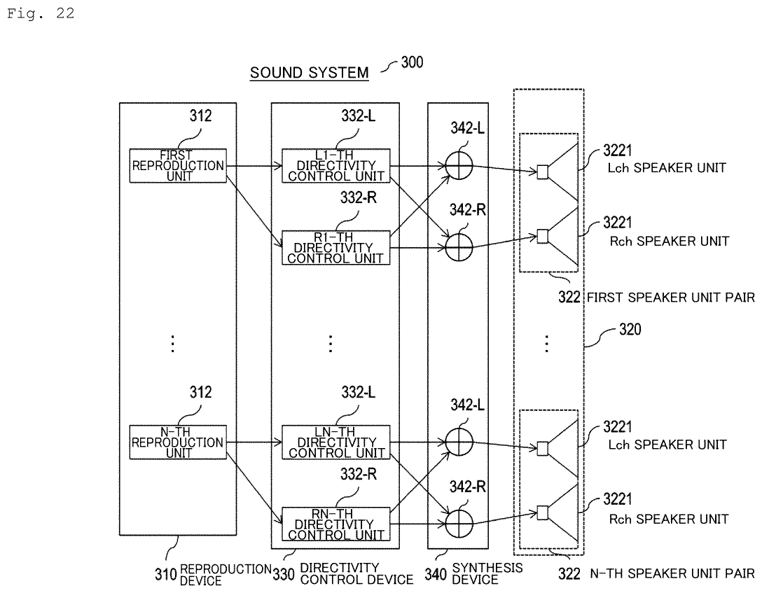

Hereinafter, a sound system 300 will be described with reference to FIG. 22. FIG. 22 is a block diagram showing a configuration of the sound system 300. As shown in FIG. 22, the sound system 300 includes a reproduction device 310, a directivity control device 330, a synthesis device 340, and a speaker system 320.

The reproduction device 310 includes N pieces (where N is an integer of 1 or more) of reproduction units 312 (that is, a first reproduction unit 312, . . . , and an N-th reproduction unit 312).

The directivity control device 330 includes 2N pieces of directivity control units 332 (that is, an L1-th directivity control unit 332-L, an LN-th directivity control unit 332-L, an R1-th directivity control unit 332-R, . . . , an RN-th directivity control unit 332-R).

The synthesis device 340 includes 2N pieces of synthesis units 342 (that is, an L1-th synthesis unit 342-L, . . . , an LN-th synthesis unit 342-L, an R1-th synthesis unit 342-R, . . . , an RN-th synthesis unit 342-R).

The speaker system 320 includes N pieces of speaker unit pairs 322 (that is, a first speaker unit pair 322, . . . , an N-th speaker unit pair 322). The speaker unit pair 322 includes two speaker units (that is, an Lch speaker unit 3221 and an Rch speaker unit 3221). The speaker system 320 is installed at a place near the head of the user who uses the seat.

Further, the Lch speaker unit 3221 and the Rch speaker unit 3221 of the n-th speaker unit pair 322 (n=1, . . . , N) are arranged in a positional relationship so that the sound emitted from the Lch speaker unit 3221 and the sound emitted from the Rch speaker unit 3221 are erased from each other so as not to be heard by a user who uses another seat.

The operations of the sound system 300 will be described in accordance with FIG. 22.

The reproduction device 310 inputs an L1-th acoustic signal and an R1-th acoustic signal, an L3-th acoustic signal and an R3-th acoustic signal, . . . , an L (2N−1)-th acoustic signal and an R (2N−1)-th acoustic signal that are acoustic signals of two channels obtained based on the reproduction objects, and outputs the L1-th acoustic signal and the R1-th acoustic signal, the L2-th acoustic signal and the R2-th acoustic signal, . . . , the L (2N)-th acoustic signal and the R (2N)-th acoustic signal. More specifically, an n-th reproduction unit 312 (n=1, . . . , N) inputs an L (2n−1)-th acoustic signal and an R (2n−1)-th acoustic signal, generates an L (2n)-th acoustic signal which is an acoustic signal having an opposite phase to the L (2n−1)-th acoustic signal from the L (2n−1)-th acoustic signal, generates an R (2n)-th acoustic signal which is an acoustic signal having an opposite phase to the R (2n-1)-th acoustic signal from the R (2n−1)-th acoustic signal, and outputs the L (2n−1)-th acoustic signal and the L (2n)-th acoustic signal and the R (2n−1)-th acoustic signal and the R (2n)-th acoustic signal. The L (2n−1)-th acoustic signal and the L (2n)-th acoustic signal are inputted to the Ln-th directivity control unit 332-L, and the R (2n−1)-th acoustic signal and the R (2n)-th acoustic signal are inputted to the Rn-th directivity control unit 332-R.

The directivity control device 330 inputs the L1-th acoustic signal and the R1-th acoustic signal, the L2-th acoustic signal and the R2-th acoustic signal, . . . , the L (2N)-th acoustic signal and the R (2N)-th acoustic signal outputted by the reproduction device 310, and outputs an L1-th processed acoustic signal which is a signal obtained by signal-processing the L1-th acoustic signal, an L2-th processed acoustic signal which is a signal obtained by signal-processing the L2-th acoustic signal, . . . , an L (2N)-th processed acoustic signal which is a signal obtained by signal-processing the L (2N)-th acoustic signal, an R1-th processed acoustic signal which is a signal obtained by signal processing the R1-th acoustic signal, an R2-th processed acoustic signal which is a signal obtained by signal processing the R2-th acoustic signal, . . . , an R (2N)-th processed acoustic signal which is a signal obtained by signal processing the R (2N)-th acoustic signal.

More specifically, an In-th directivity control unit 332-L (n=1, . . . . N) inputs an L (2n−1)-th acoustic signal and an L (2n)-th acoustic signal, generates an L (2n−1)-th processed acoustic signal from the L (2n−1)-th acoustic signal and an L (2n)-th processed acoustic signal from the L (2n)-th acoustic signal by executing predetermined signal processing, and outputs the L (2n−1)-th processed acoustic signal and the L (2n)-th processed acoustic signal.

Similarly, an Rn-th directivity control unit 332-R (n=1, . . . , N) inputs an R (2n−1)-th acoustic signal and an R (2n)-th acoustic signal, generates an R (2n−1)-th processed acoustic signal from the R (2n−1)-th acoustic signal and an R (2n)-th processed acoustic signal from the R (2n)-th acoustic signal by executing predetermined signal processing, and outputs the R (2n−1)-th processed acoustic signal and the R (2n)-th processed acoustic signal.

Here, the predetermined signal processing is processing for controlling the directivity described in the second embodiment, and includes, for example, filter processing having coefficients as described below.

The following is a specific description. The region to be audible and the region not to be audible need to be designed in accordance with the case. For example, a case to be installed in a seat (hereinafter referred to as a seat S) of an automobile is considered. In the Ln-th directivity control unit 332-L, the position where the left ear of the user who uses the seat S is present is included in the region to be audible, and other positions are included in the region not to be audible. In addition, in the Rn-th directivity control unit 332-R, the position where the right ear of the user who uses the seat S comes is included in the region to be audible, and other positions are included in the region not to be audible. Therefore, for example, in the Ln-th directivity control unit 332-L, the value of the filter coefficient is made to approach 0 in a microphone installed in a region including a left seat close to the seat S but not including a position where a left ear of the user who uses the seat S is present. In the Rn-th directivity control unit 332-R, the value of the filter coefficient is made to approach 0 in a microphone installed in a region including a right seat close to the seat S but not including a position where a right ear of a user who uses the seat S is present. In short, the microphone installed in the region where the user's ear is assumed to be present should be controlled so that the filter coefficient is made to approach 1, or the microphone installed in the region where the user's ear is assumed not to be present should be controlled so that the filter coefficient is made to approach 0. In other words, the filter may be configured so that the sound as large as possible may arrive in the region where the user's ear is assumed to be present, and the sound as small as possible may arrive in the region where the user's ear is assumed not to be present.

As a result, the Ln-th directivity control unit (n=1, . . . . N) executes the signal processing so that the sound emitted from the Lch speaker unit of the n-th speaker unit pair and the sound emitted from the Rch speaker unit of the n-th speaker unit pair can be heard in the region to be audible in the vicinity of the n-th speaker unit pair (for example, a position where the left ear of the user is present) and cannot be heard in the region not to be audible.

Similarly, the Rn-th directivity control unit (n=1, . . . , N) executes the signal processing so that the sound emitted from the Rch speaker unit of the n-th speaker unit pair and the sound emitted from the Lch speaker unit of the n-th speaker unit pair can be heard in the region to be audible in the vicinity of the n-th speaker unit pair (for example, a position where the right ear of the user is present) and cannot be heard in the region not to be audible.

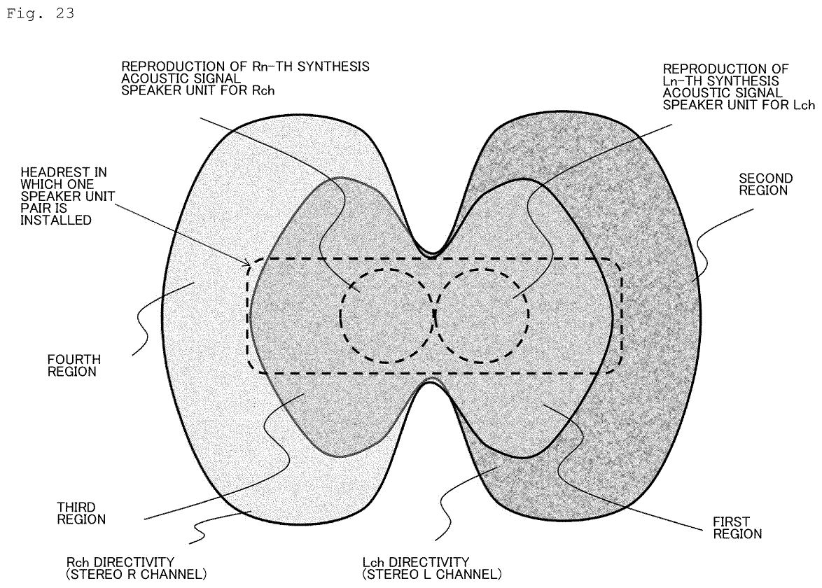

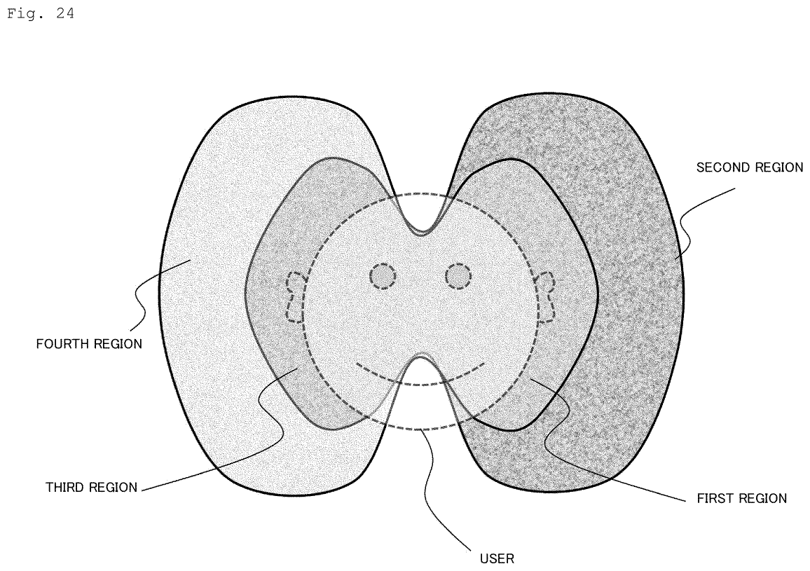

FIG. 23 and FIG. 24 are diagrams for explaining the region to be audible and the region not to be audible. The Rch speaker unit and the Lch speaker unit are arranged in a horizontal direction and installed on the headrest. Here, it is assumed that the head of the user is located near the center of the speaker unit pair. The stereo L channel is reproduced by using the L channel directivity created in advance by the fixed filter, and the stereo R channel is reproduced by using the R channel directivity, so that stereo reproduction can be performed by the speaker unit pair composed of two speaker units.

Note that the L (2n−1)-th processed acoustic signal is an acoustic signal that is heard in a region in a left direction (hereinafter, referred to as a first region) with respect to a direction in which a user faces as a reference when heard from the center of the speaker unit pair out of the R channel directivity. The R (2n)-th processed acoustic signal is an acoustic signal that is not heard in a region in a right direction (hereinafter referred to as a fourth region) with respect to a direction in which a user faces as a reference when heard from the center of the speaker unit pair out of the R channel directivity.

Similarly, the R (2n−1)-th processed acoustic signal is an acoustic signal that is heard in a region in a right direction (hereinafter referred to as a third region) with respect to a direction in which a user faces as a reference when heard from the center of the speaker unit pair out of the L channel directivity. The L (2n)-th processed acoustic signal is an acoustic signal that is not heard in a region in a left direction (hereinafter referred to as a second region) with respect to a direction in which a user faces as a reference when heard from the center of the speaker unit pair out of the L channel directivity.

The synthesis device 340 inputs the L1-th processed acoustic signal, the L2-th processed acoustic signal, . . . , the L (2N)-th processed acoustic signal, and the R1-th processed acoustic signal, the R2-th processed acoustic signal, . . . , the R (2N)-th processed acoustic signal, synthesizes these signals, obtains and outputs an L1-th synthesis acoustic signal, an L2-th synthesis acoustic signal, . . . , an LN-th synthesis acoustic signal, an R1-th synthesis acoustic signal, an R2-th synthesis acoustic signal, . . . , an RN-th synthesis acoustic signal.

More specifically, an Ln-th synthesis unit 342-L (n=1, . . . , N) inputs the L (2n−1)-th processed acoustic signal and the R (2n)-th processed acoustic signal, synthesizes these signals, and obtains an In-th synthesis acoustic signal.

Similarly, an Rn-th synthesis unit 342-R (n=1, . . . , N) inputs the R (2n−1)-th processed acoustic signal and the L (2n)-th processed acoustic signal, synthesizes these signals, and obtains an Rn-th synthesis acoustic signal.

The speaker system 320 inputs the L1-th synthesis acoustic signal, the L2-th synthesis acoustic signal, . . . , the LN-th synthesis acoustic signal and the R1-th synthesis acoustic signal, the R2-th synthesis acoustic signal, . . . , the RN-th synthesis acoustic signal outputted by the synthesis device 340, and emits a sound based on the L1-th synthesis acoustic signal, a sound based on the L2-th synthesis acoustic signal, . . . , a sound based on the LN-th synthesis acoustic signal, and a sound based on the R1-th synthesis acoustic signal, a sound based on the R2-th synthesis acoustic signal, . . . , a sound based on the RN-th synthesis acoustic signal. More specifically, an n-th speaker unit pair 322 (n=1, . . . , N) inputs the Ln-th synthesis acoustic signal and the

Rn-th synthesis acoustic signal, and emits a sound based on the Ln-th synthesis acoustic signal from the Lch speaker unit 3221, and emits a sound based on the Rn-th synthesis acoustic signal from the Rch speaker unit 3221. An element based on the L (2n−1)-th processed acoustic signal of the Ln-th synthesis acoustic signal and an element based on the L (2n)-th processed acoustic signal of the Rn-th synthesis acoustic signal have an opposite phase relationship from each other, and an element based on the R (2n−1)-th processed acoustic signal of the Rn-th synthesis acoustic signal and an element based on the R (2n)-th processed acoustic signal of the Ln-th synthesis acoustic signal have an opposite phase relationship, so that a sound is heard only in the vicinity of a seat where the speaker system 320 is installed, as described in <Technical Background>. For example, in the case where N=1 is established, when the L1-th acoustic signal and the R1-th acoustic signal which are acoustic signals of two channels obtained based on the reproduction objects are defined as an acoustic signal of a left channel and an acoustic signal of a right channel of a certain sound source, stereo sound can be heard only in the vicinity of a seat where the speaker system 320 is installed.

Note that the sound emitted in the n-th user direction from the Lch speaker unit 3221 of the n-th speaker unit pair 322 and the sound emitted in the opposite direction to the n-th user direction from the Lch speaker unit 3221 of the n-th speaker unit pair 322 have an opposite phase relationship from each other. Similarly, the sound emitted in the n-th user direction from the Rch speaker unit 3221 of the n-th speaker unit pair 322 and the sound emitted in the opposite direction to the n-th user direction from the Rch speaker unit 3221 of the n-th speaker unit pair 322 have an opposite phase relationship from each other.

According to the embodiments of the present invention, it is possible to reproduce a sound that can be heard only in a very limited narrow range in a vicinity of a speaker system, and to perform stereo reproduction by a speaker unit pair composed of two speaker units.

Note that the present embodiment and the modification example of the second embodiment may be combined.

In addition, in the present embodiment, the directivity control is realized by the array signal processing described in the second embodiment, but it may be realized by using a directivity speaker.

Further, in the present embodiment, an example where N=1 is established has been described, but N may be any of integers of 2 or more, and even when N is an integer of 2 or more, localized reproduction can be performed, and acoustic signals of N pieces of stereo channels can be reproduced by N pieces of speaker unit pairs, respectively.

### Additional Note

The above description of the embodiments of the present invention is presented for the purpose of illustration and description. There is no intention to be exhaustive and there is no intention to limit the invention to a disclosed exact form. Modifications or variations are possible from the above-mentioned teachings. The embodiments are selectively represented in order to provide the best illustration of the principle of the present invention and in order for those skilled in the art to be able to use the present invention in various embodiments and with various modifications so that the present invention is suitable for deliberated practical use. All of such modifications or variations are within the scope of the present invention defined by the appended claims interpreted according to a width given fairly, legally and impartially.

1. A sound system comprises a speaker unit pair comprising at least a first speaker not comprising a speaker box and a second speaker not comprising a speaker box, wherein
an L (2n−1)-th acoustic signal is an acoustic signal of one channel of stereo channels of a predetermined sound source, an R (2n−1)-th acoustic signal is an acoustic signal of the other channel of the stereo channels,
an L (2n)-th acoustic signal is an acoustic signal of an opposite phase to that of the L (2n−1)-th acoustic signal,
an R (2n)-th acoustic signal is an acoustic signal of an opposite phase to that of the R (2n−1)-th acoustic signal,
the first speaker emits a sound based on an L (2n−1)-th processed acoustic signal with signal processing to make it audible in a first region in an L direction to the L (2n−1)-th acoustic signal and an R (2n)-th processed acoustic signal with signal processing to make it non-audible in a fourth region in an R direction to the R (2n)-th acoustic signal, and
the second speaker emits a sound based on an L (2n)-th processed acoustic signal with signal processing to make it non-audible in a second region in an L direction to the L (2n)-th acoustic signal and an R (2n−1)-th processed acoustic signal with signal processing to make it audible in a third region in an R direction to the R (2n−1)-th acoustic signal.

2. A sound system, where N is an integer of 1 or more, comprising:
a reproduction device configured to comprise processing circuitry configured to implement an n-th reproduction unit (n=1, . . . , N) that outputs an L (2n−1)-th acoustic signal which is an acoustic signal of one channel of stereo channels of a predetermined sound source, an L (2n)-th acoustic signal which is an acoustic signal of an opposite phase to that of the L (2n−1)-th acoustic signal, an R (2n−1)-th acoustic signal which is an acoustic signal of the other channel of the stereo channels, and an R (2n)-th acoustic signal which is an acoustic signal of an opposite phase to that of the R (2n−1)-th acoustic signal;
a directivity control device configured to comprise processing circuitry configured to implement an Ln-th directivity control unit (n=1, . . . , N) that generates an L (2n−1)-th processed acoustic signal from the L (2n−1)-th acoustic signal and generates an L (2n)-th processed acoustic signal from the L (2n)-th acoustic signal by performing predetermined signal processing, and an Rn-th directivity control unit (n=1, . . . , N) that generates an R (2n−1)-th processed acoustic signal from the R (2n−1)-th acoustic signal and generates an R (2n)-th processed acoustic signal from the R (2n)-th acoustic signal by performing predetermined signal processing;
a synthesis device configured to comprise processing circuitry configured to implement an Ln-th synthesis unit (n=1, . . . , N) that obtains an Ln-th synthesis acoustic signal by synthesizing the L (2n−1)-th processed acoustic signal and the R (2n)-th processed acoustic signal, and an Rn-th synthesis unit (n=1, . . . , N) that obtains an Rn-th synthesis acoustic signal by synthesizing the R (2n−1)-th processed acoustic signal and the L (2n)-th processed acoustic signal; and
a speaker system configured to comprise an n-th speaker unit pair (n=1, . . . , N) that comprises a speaker unit (hereinafter referred to as an Lch speaker unit) that emits a sound based on the Ln-th synthesis acoustic signal and a speaker unit (hereinafter referred to as an Rch speaker unit) that emits a sound based on the Rn-th synthesis acoustic signal, wherein
signal processing executed by the Ln-th directivity control unit (n=1, . . . , N) is processing so that the sound emitted from the Lch speaker unit of the n-th speaker unit pair and the sound emitted from the Rch speaker unit of the n-th speaker unit pair can be heard in a region to be audible in a vicinity of the n-th speaker unit pair in an L direction and cannot be heard in a region not to be audible in an R direction, and
signal processing executed by the Rn-th directivity control unit (n=1, . . . , N) is processing so that the sound emitted from the Rch speaker unit of the n-th speaker unit pair and the sound emitted from the Lch speaker unit of the n-th speaker unit pair can be heard in a region to be audible in a vicinity of the n-th speaker unit pair in an R direction and cannot be heard in a region not to be audible in an L direction.

3. The sound system according to claim 2, wherein
N=1 is established,
the Lch speaker unit and the Rch speaker unit are installed on a headrest of a seat of an automobile.
